(19) United States
(12) Patent Application Publication
(10) Pub. No.: US 2006/0202082 A1
(43) Pub. Date: Sep. 14, 2006

(54) Microjet actuators for the control of flow separation and distortion

(76) Inventor: Farrukh S. Alvi, Tallahassee, FL (US)

Correspondence Address: Pennington, Moore, Wilkinson;Bell & Dunbar, P.A., 2nd Floor, 215 S. Monroe St,, Tallahassee, FL, 32301, US

(21) Appl. No.: 11/329,721

(22) Filed: Jan. 11, 2006

Related U.S. Application Data
(60) Provisional application No. 60/646,951, filed on Jan. 21, 2005.

(51) Int. Cl. B64C 29/00

(52) U.S. Cl. 244/12.1; 244/73 R; 60/263

(57) ABSTRACT

A system for controlling unwanted flow separation. One or more microjets are placed to feed auxiliary fluid into a region of suspected flow separation. If the separation is intermittent, sensors can be employed to detect its onset. Once separation is developing, the microjets are activated to inject a stream of fluid into the separation region. This injected fluid affects the flow and serves to control the flow separation. A steady-state embodiment can be used to continuously fluid. On the other hand, sensors and a rapidly reactive control circuit can be used to inject fluid only when it is needed to inhibit flow separation. The sensors and control circuit can operate off of simple pressure gradient detection or predictive algorithms that anticipate when flow separation will occur.

### CROSS-REFERENCES TO RELATED APPLICATIONS

This application is a non-provisional application claiming the benefit of an earlier-filed provisional application pursuant to the provisions of 37 C.F.R. §1.53. The earlier-filed provisional application listed the same inventor. It was filed on Jan. 21, 2005 and was assigned application Ser. No. 60/646,951.

### STATEMENT REGARDING FEDERALLY SPONSORED RESEARCH OR DEVELOPMENT

This invention involves federally sponsored research. The sponsoring agency is the National. Aeronautics and Space Administration.

### MICROFICHE APPENDIX

Not Applicable

### BACKGROUND OF THE INVENTION

1. Field of the Invention

This invention relates to the field of flow control in a fluid. More specifically, the invention comprises the use of properly placed microjets to control flow separation and or recirculation over a given surface.

2. Description of the Related Art

Flow separation is defined as the detachment of a flowing fluid from a solid surface. It is generally caused by a severe pressure gradient. The gradient itself may result from a geometric feature on the solid surface, or simply placing the surface at a high angle of attack with respect to the airstream. Whatever the cause, flow separation produces a significant thickening of the turbulent region adjacent to the solid surface. The boundary layer may even detach from the surface to produce a region of reverse flow. Such reverse flow can be intermittent or continuous.

Flow separation is undesirable in many applications. One example is the complex inlet ducting used to feed air to an aircraft engine. Such inlets are now commonly curved, so that the high radar signature of the compressor will not be directly visible. FIG. 1 illustrates a serpentine inlet 10, which is one example of many types. The intake is toward the left side of the view with the engine compressor being located proximate the exhaust portion in the right side of the view. The reader will observe that the air flow bends through a circuitous path and transitions from a four-sided intake section to the round section needed at the compressor intake.

Such an inlet is designed to handle large amounts of air flow. Flow separation is a known problem in such applications. Those skilled in the art will know that the serpentine may experience variable flow. As the aircraft maneuvers—often undergoing substantial angles of attack in pitch and yaw—the pressure distribution across the intake varies significantly. This variance produces flow separation in different locations at different times. A substantial flow separation can degrade the engine performance and even lead to compressor stall.

The prior art includes several approaches to reducing and controlling flow separation. These include: (1) Injecting pressurized air in a direction which is tangential to the flow—such as slotted aircraft flaps; (2) Applying vacuum to the boundary layer by using vacuum orifices or a permeable surface; (3) Adding vortex generators, such as vanes or bumps; and (4) Adding forced excitation devices such as synthetic jets (which include no net mass flux, but create an effect similar to devices which add or subtract mass to the flow). The prior art approaches clearly indicate the desirability of controlling flow separation.

### BRIEF SUMMARY OF THE INVENTION

The present invention comprises a system for controlling unwanted flow separation in a fluid flowing over a surface. The fluid can be compressible (such as air) or incompressible (such as water). One or more microjets are placed to feed auxiliary fluid into a region of suspected flow separation. If the separation is intermittent, sensors can be employed to detect its onset. Once separation is developing, the microjets are activated to inject a stream of fluid into the separation region. This injected fluid affects the flow and serves to control the flow separation.

A steady-state embodiment can be used to continuously fluid. On the other hand, sensors and a rapidly reactive control circuit can be used to inject fluid only when it is needed to inhibit flow separation. The sensors and control circuit can operate off of simple pressure gradient detection or predictive algorithms that anticipate when flow separation will occur.

### BRIEF DESCRIPTION OF THE SEVERAL VIEWS OF THE DRAWINGS

FIG. 1 is a perspective view, showing a serpentine inlet for an aircraft engine.

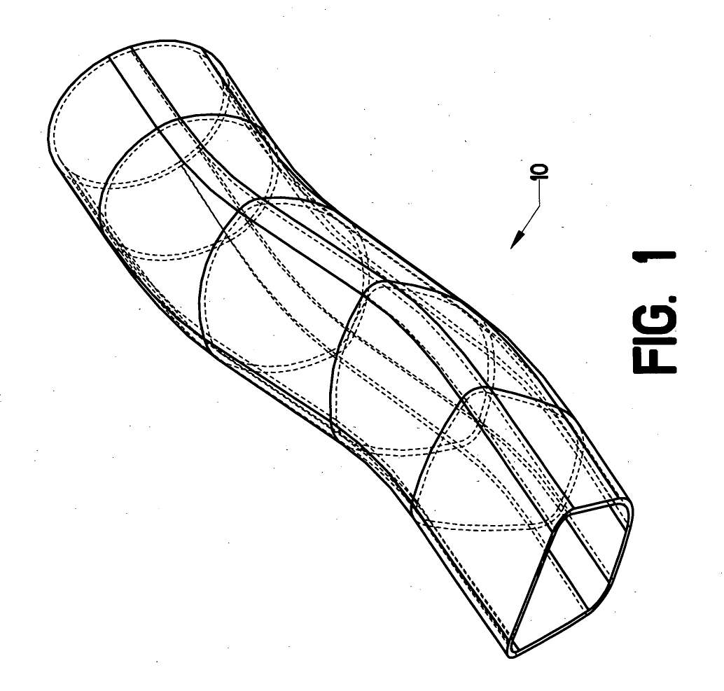

FIG. 2 is a perspective view, showing an adverse pressure gradient ramp.

FIG. 3 is a side elevation view, showing flow across a high adverse pressure gradient.

FIG. 4 is a perspective view, showing one embodiment of the present invention.

FIG. 5 is a detail view, showing a microjet.

FIG. 6 is a side elevation view, showing flow when the microjets are in use.

FIG. 7 is a perspective view, showing another embodiment of the present invention.

FIG. 8 is a perspective view, showing the application of the present invention to an airfoil.

FIG. 9 is a perspective view, showing the application of two microjet clusters on a simplified symmetric wing.

FIG. 10 is a partial perspective view showing one of the microjet clusters from FIG. 9.

FIG. 11 is a partial perspective view, showing the use of appropriate microjets to preserve non-separated flow with a high angle of attack.

FIG. 12 is a partial perspective view, showing flow separation when no microjets are active.

FIG. 13 is a partial perspective view, showing more severe flow separation caused by activating appropriate microjets.

FIG. 14 is a perspective view, showing the use of microjets to create differential flow separation and a rolling moment.

FIG. 15 is a partial perspective view, showing the placement of a microjet array near an airfoil's leading edge.

REFERENCE NUMERALS IN THE DRAWINGS

| | | | |
|---|---|---|---|
| 10 | serpentine inlet | 12 | pressure gradient ramp |
| 14 | air flow | 18 | high adverse pressure gradient |
| 20 | velocity vector | 22 | reverse flow |
| 24 | separated flow zone | 26 | microjet |
| 28 | high pressure manifold | 30 | microjet flow |
| 34 | first jet array | 36 | second jet array |
| 38 | third jet array | 40 | airfoil |
| 42 | incoming boundary layer | 44 | boundary layer separation |
| 46 | wing | 48 | aileron |
| 50 | fourth jet array | 52 | fifth jet array |
| 54 | sixth jet array | 56 | microjet cluster |
| 58 | separated flow | 60 | unseparated flow |
| 62 | incoming flow | | |

### DETAILED DESCRIPTION OF THE INVENTION

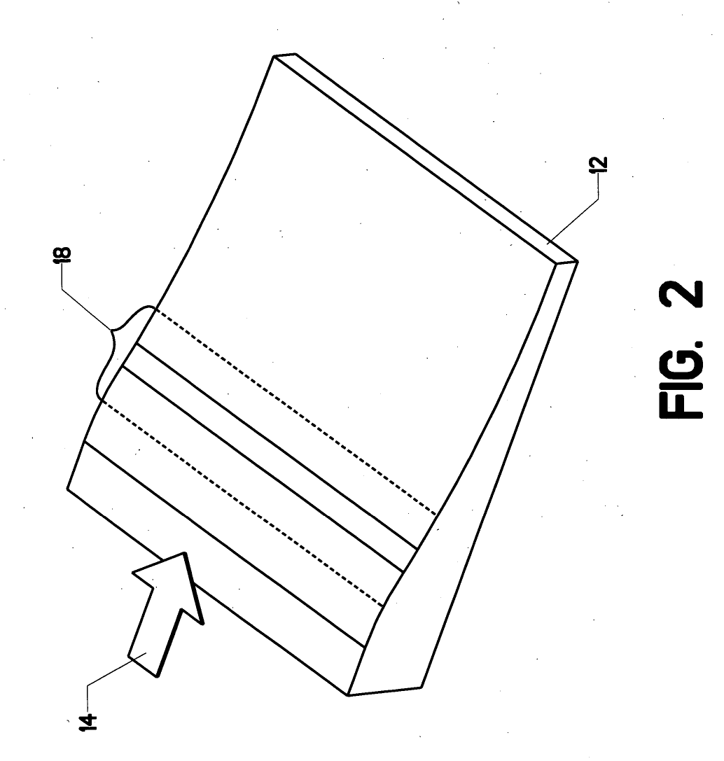

The present invention can be applied to flow control over many different types of surfaces. As an initial explanation, however, it is useful to describe its application to one particular type of simple surface. FIG. 2 shows an adverse pressure gradient ramp 12. If air flow 14 is directed over the ramp at an appropriate velocity, flow separation will occur in the region of high adverse pressure gradient 18. Air flowing over this geometry produces an adverse pressure gradient. The pressure coefficient is defined by the following expression:

$${C}_{p} = \frac{( {P}_{surface} - {P}_{∞} )}{0.5 ρ \cdot {U}_{∞}^{2}}$$

In this expression, ρ is the density of the fluid and U_{∞} is the undisturbed flow velocity, well away from the ramp.

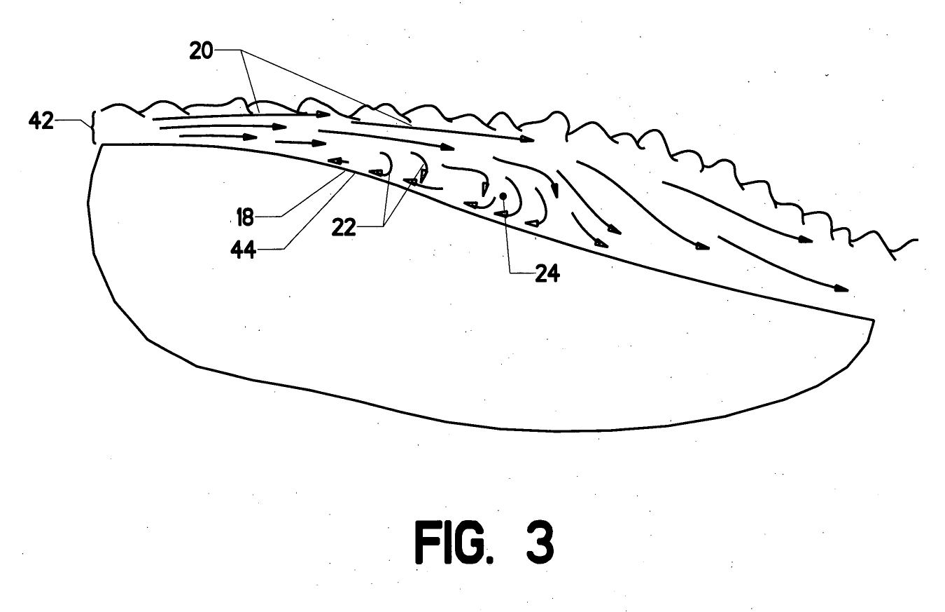

FIG. 3 is a detailed elevation view of the ramp surface in the region of high adverse pressure gradient 18. The approaching flow is represented by velocity vectors 20. Those skilled in the art will be familiar with this type of depiction. The reader will observe that the flow in the vicinity of the highest surface gradient has actually reversed (reverse flow 22). A region of circulating flow has arisen. Because this region is separated from the relatively smooth flow over the bulk of the ramp, it is denoted as a separated flow zone 24.

The existence of the separated flow zone can produce many results. These include: (1) In the case of an air-cooled surface, a localized “hot spot” due to inadequate flow; (2) In the case of an airfoil, premature stall; (3) In the case of an aircraft control surface, loss of control effectiveness.

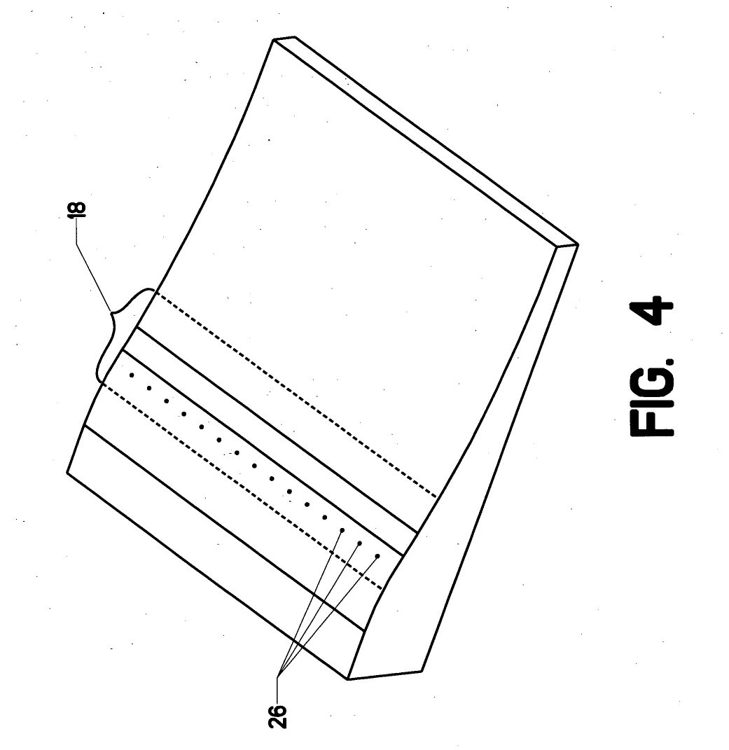

The present invention seeks to reduce or eliminate this separated flow zone through the use of microjets. FIG. 4 shows a modified version of the pressure gradient ramp. This version incorporates an array of high-speed microjets 26. These are generally oriented transversely to the flow. In other words, they are oriented to inject air upward with respect to the orientation shown in the view.

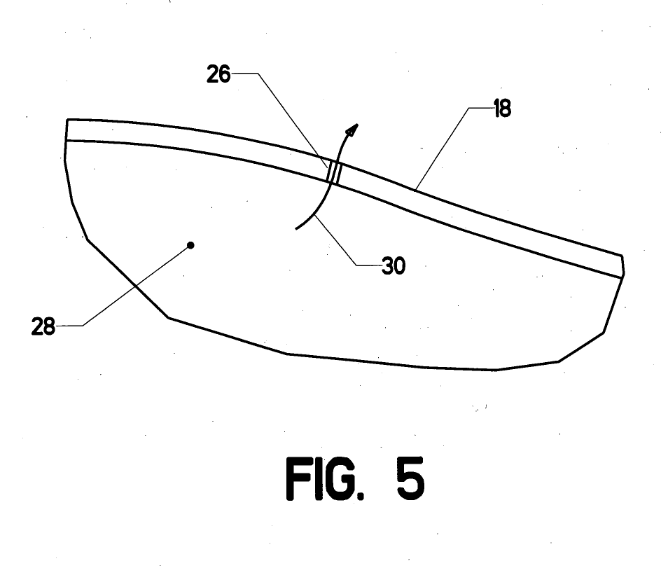

FIG. 5 shows a sectional view through a portion of the ramp's wall. The ramp has a hollow interior, which can be pressurized to create high pressure manifold 28. Microjet 26 connects high pressure manifold 28 to the surrounding flow. Thus, when the manifold is pressurized, microjet flow 30 is propelled into the slipstream. Those skilled in the art will know that many techniques could be used to feed pressurized flow to the microjets, with the ones illustrated merely being representative. Many embodiments would include a flow control device near the microjet itself. This device would be capable of rapidly turning the jet on and off, and possibly throttling the flow.

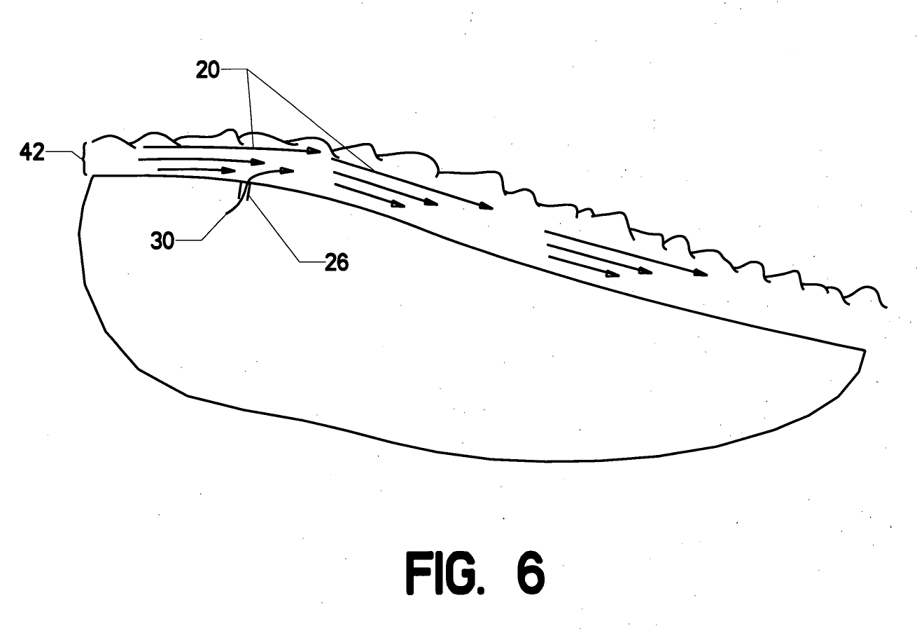

If the microjet is properly placed, and an appropriate differential pressure across the microjet is provided, it can eliminate or significantly reduce the separated flow zone. FIG. 6 graphically depicts this function. The reader will observe that the region of reversing flow has been eliminated.

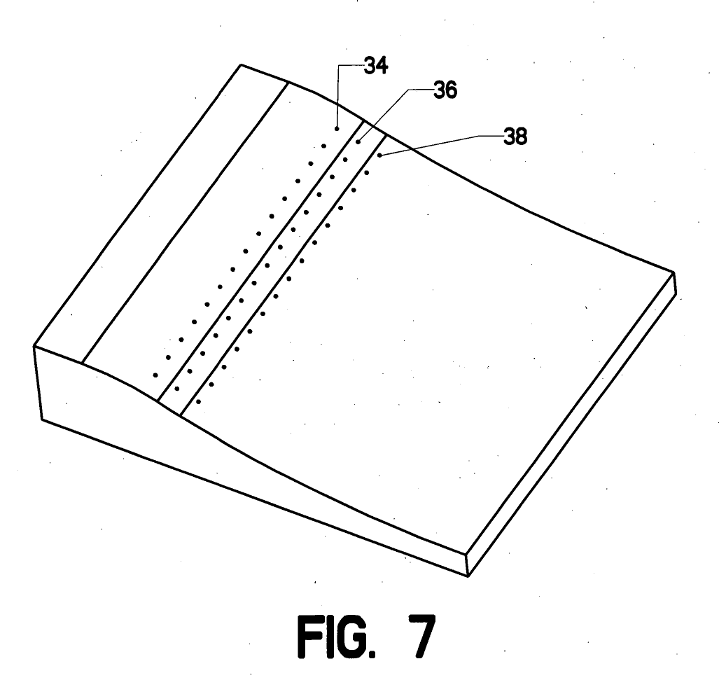

Greater control is possible with a more complex array of microjets. FIG. 7 shows such an embodiment, employing three arrays of microjets. These are denoted as first jet array 34, second jet array 36, and third jet array 38. These arrays are preferably fed by individual manifolds so that they can be activated independently. The use of such a staggered array assists in flow control over a wider range of velocities.

Pressure and flow sensors can be added to sense the existence and location of separating flow. Computer control can be used to activate the appropriate microjet array to impede the separating flow. Of course, the flow phenomena may change rapidly. Thus, the control system should contemplate rapid activation and deactivation of the microjet arrays.

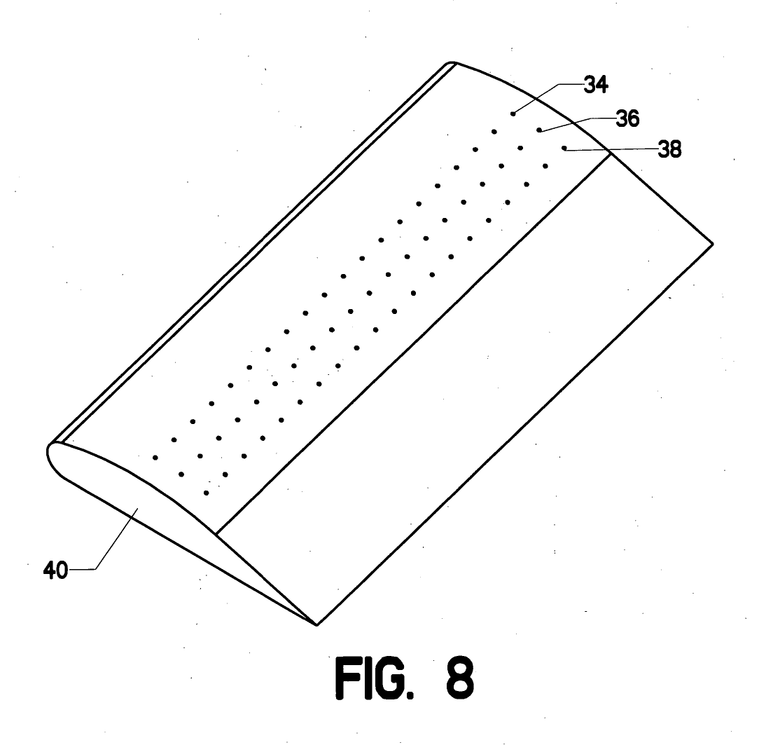

The pressure gradient ramp has been illustrated in order to explain the general concepts of the invention. The microjets can be applied to many other aerodynamic surfaces, however. FIG. 8 shows airfoil 40. The profile shown is one commonly used for trailing edge flaps on aircraft wings. Flow separation can occur on such flaps along the upper trailing surface. Such flow separation degrades the flap's performance, thereby reducing the wing's overall lift. In severe circumstances such a flow separation can even cause the wing as a whole to stall.

The airfoil shown in FIG. 8 has been modified by the addition of three arrays of microjets. These can be activated to reduce or eliminate flow separation along the flap's trailing edge. To date, experiments indicate that a relatively low feed pressure can be used for the microjets. Pressures in the range of 20 to 50 psig can be effective (in some instances even lower). Those skilled in the art of aircraft systems will know that air flow bled from one of the stages of a jet engine's compressor can provide such pressures at sufficient flow rates. Thus, compressor bleed air can be used to provide the air necessary to drive the microjets.

The “plumbing” required to handle the pressurized air can also be relatively simple, since the pressures are low. Thus, although a trailing edge flap must move through an arc, a simple rotary union or flexible fitting can be used to supply pressurized bleed air to one or more manifolds inside the flap. Unlike hydraulic circuits, losses within such a system would not be critical. It is also significant to note that high-speed air control valves are widely available. This fact allows the microjets to be rapidly modulated if necessary.

In addition to providing increased airfoil performance, microjet arrays can also provide control forces. Those skilled in the art will know that aircraft are typically controlled in at least three degrees of freedom—roll, pitch, and yaw. Control forces are generally created by the activation of ailerons, elevators, and a rudder. The activation of such moving control surfaces create sharp discontinuities in the aircraft's exterior surfaces, which can significantly increase the aircraft's radar signature.

Providing control moments without actually moving control surfaces is advantageous. Reaction control systems have provided such control forces for many years, with examples including the Hawker Harrier (AV-8 in the U.S. designation) and the Lockheed NF-104. Microjet arrays can provide such forces using the existing air flow over an aircraft.

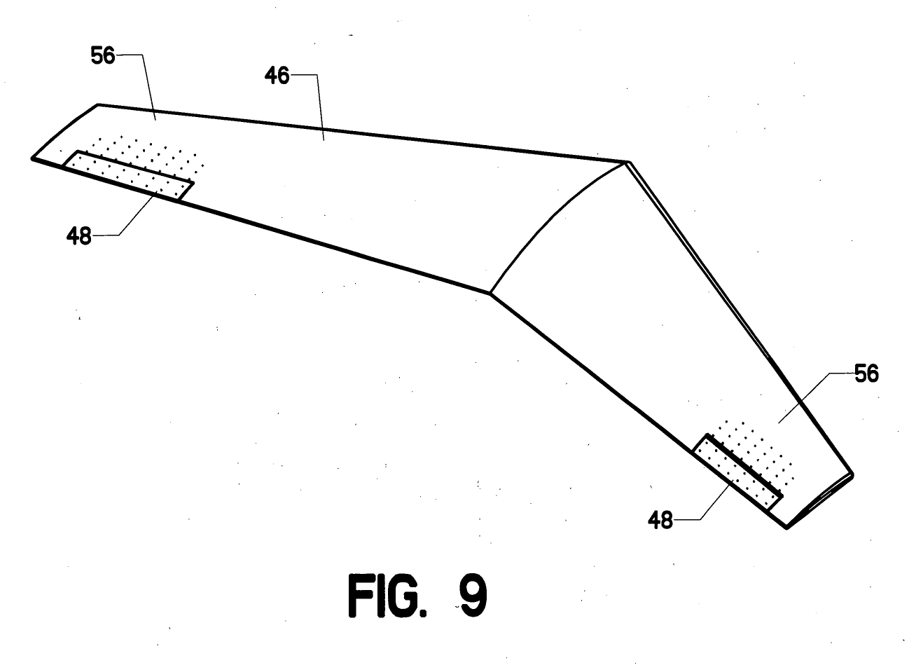

FIG. 9 shows a simplified wing 46. It is a symmetric swept airfoil. This depiction is useful for illustrating the principles of microjet control, though it obviously omits many other features found on aircraft, such as other control surfaces, a fuselage, etc. Two conventional ailerons 48 are present. A microjet cluster 56 is located proximate each aileron.

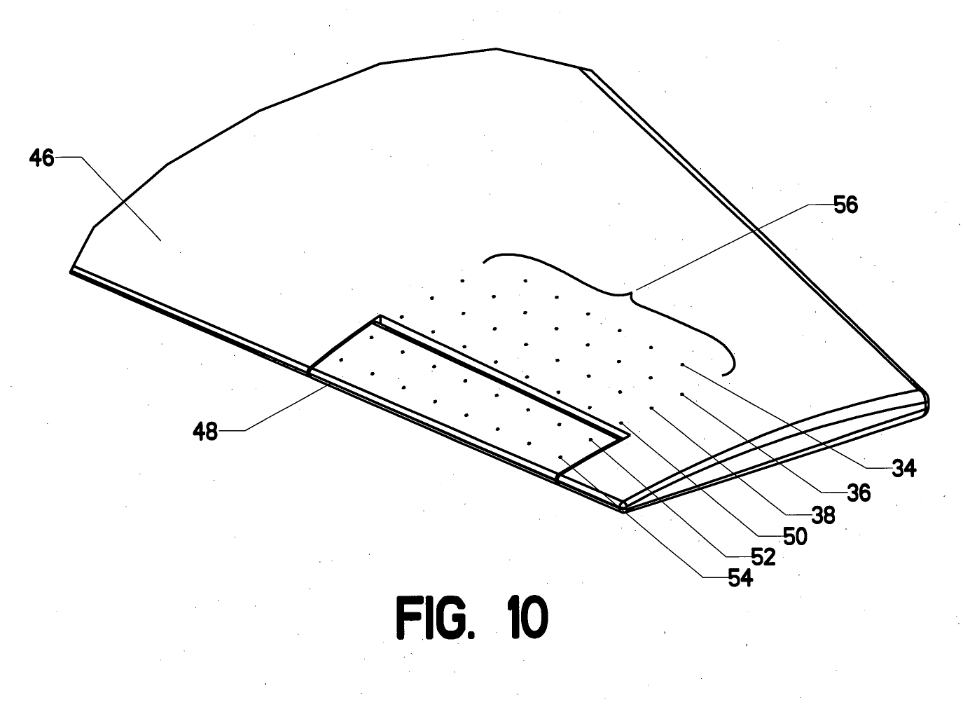

FIG. 10 shows a closer view of one of the microjet clusters. The embodiment shown uses clusters which are grouped in linear arrays. Each linear array is approximately perpendicular to the direction of the flow. They are denoted as first jet array 34, second jet array 36, third jet array 38, fourth jet array 50, fifth jet array 52, and sixth jet array 54. The last two arrays are actually located on the movable aileron.

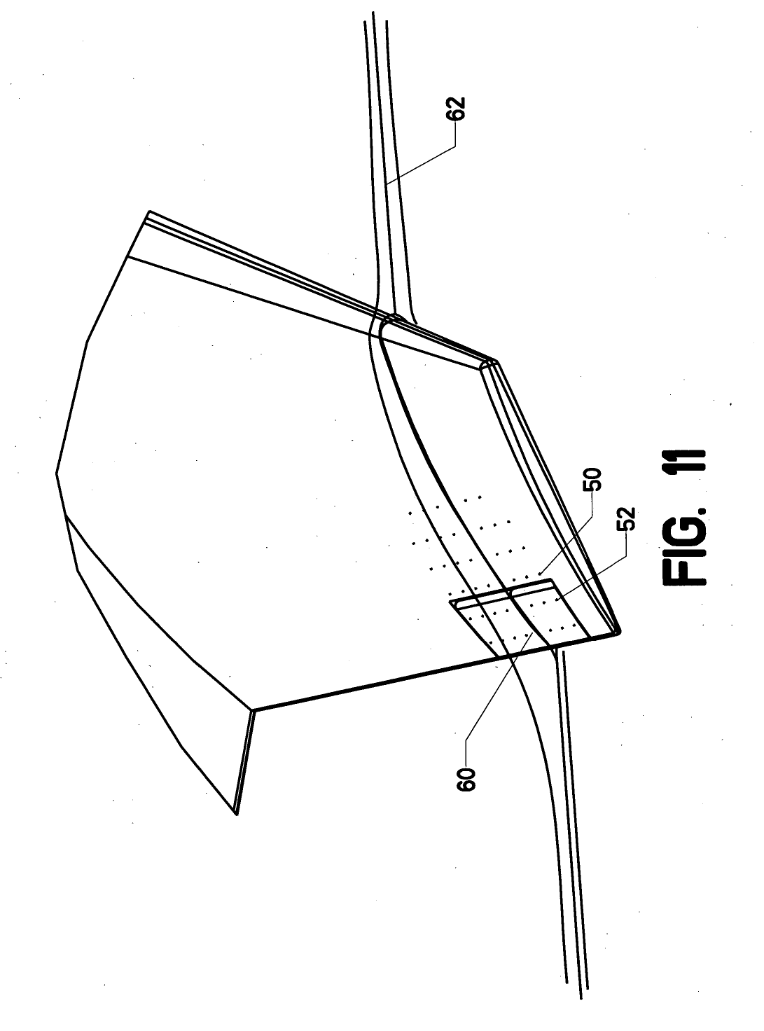

Conventional control of the aircraft is still possible using movable control surfaces. However, FIGS. 11-14 illustrate how microjet control is also possible. FIG. 11 shows airflow over the wing when the wing is placed at a fairly high angle of attack. Those skilled in the art will be familiar with the depiction of airflow as streamlines. Incoming flow 62 splits and flows around the wing. Appropriate microjet arrays have been activated in order to prevent flow separation (in a fashion similar to the depiction in FIG. 6). Fourth jet array 50 and fifth jet array 52 have been activated in this case. The result is unseparated flow 60.

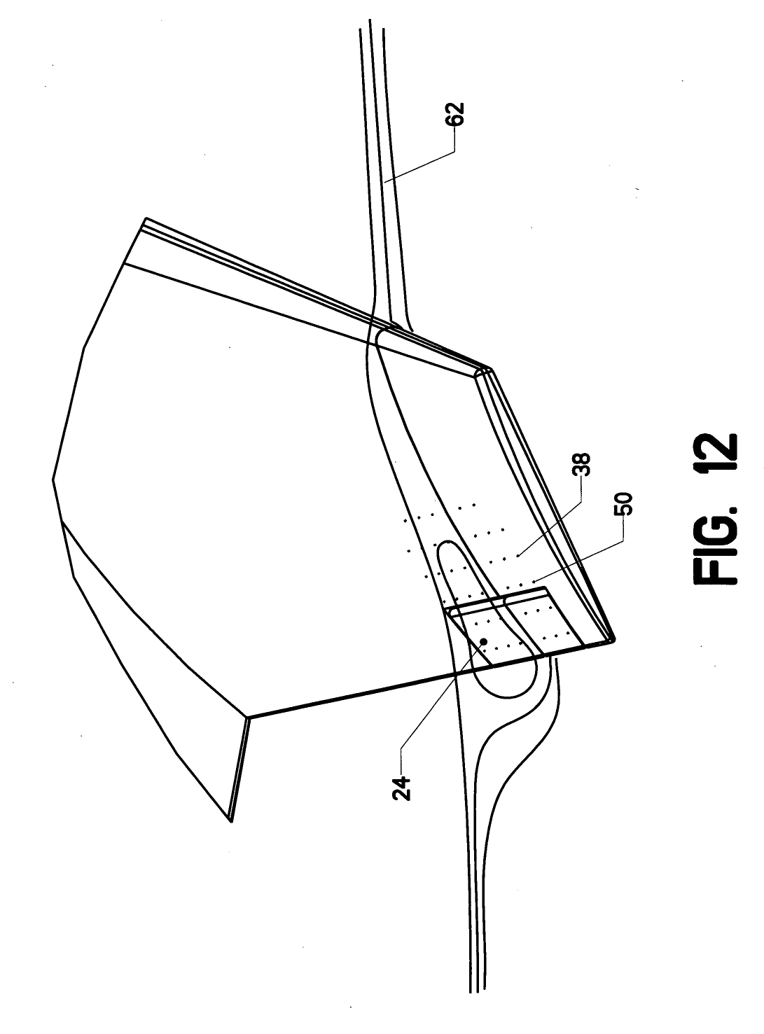

If the microjets are turned off in this scenario flow separation will occur. FIG. 12 shows this state. Separated flow zone 24 has arisen. The wing has not actually stalled, but a significant portion of its surface area has been effectively lost. The lift produced by the wing is therefore reduced.

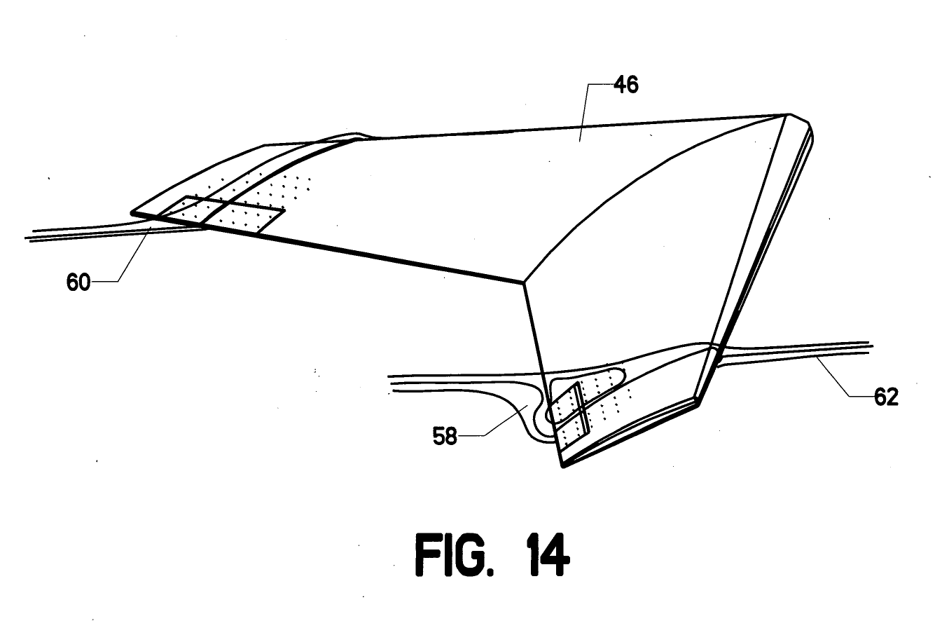

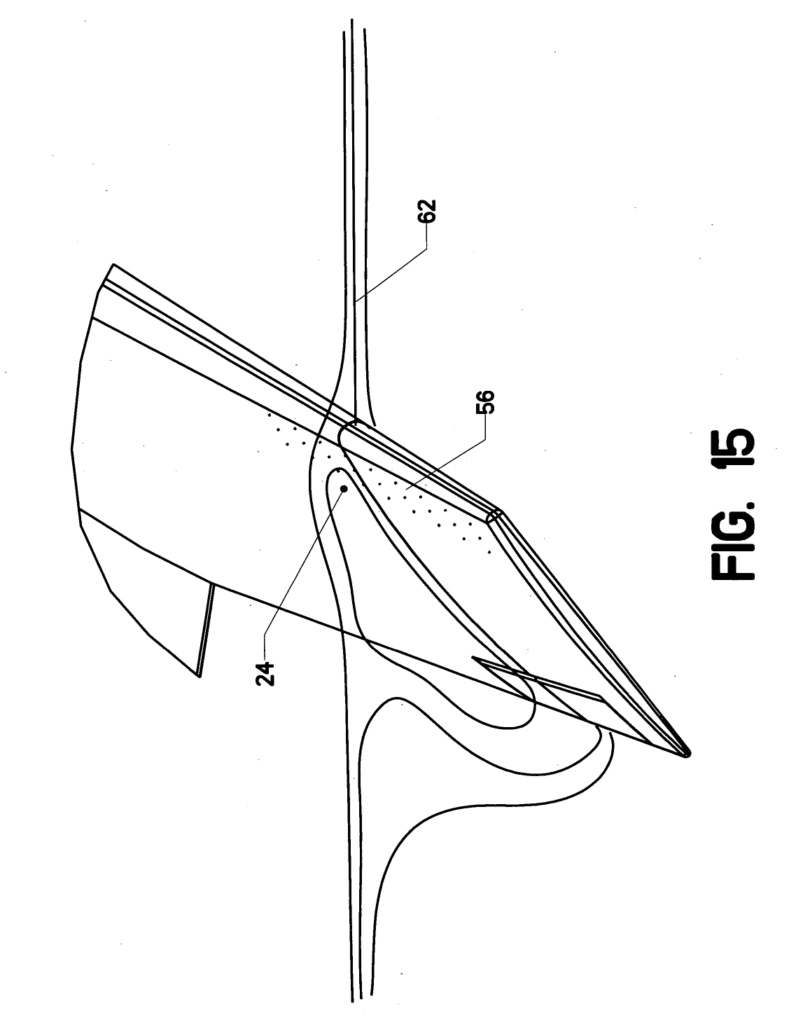

The array shown in FIGS. 11 and 14 is positioned on the trailing half of the wing's cross section. In many instances, however, it will be advantageous to place the array near the wing's leading edge. FIG. 15 shows the same wing proceeding through the air at an even higher angle of attack. Separated flow zone 24 commences near the wing's leading edge. Microjet cluster 56 is accordingly placed very close to the leading edge, in order to inject flow at the point where it will be most effective in reducing or eliminating the separated flow zone. In fact, in some instances, it may be advantageous to place microjets over a large expanse from the leading edge to the trailing edge.

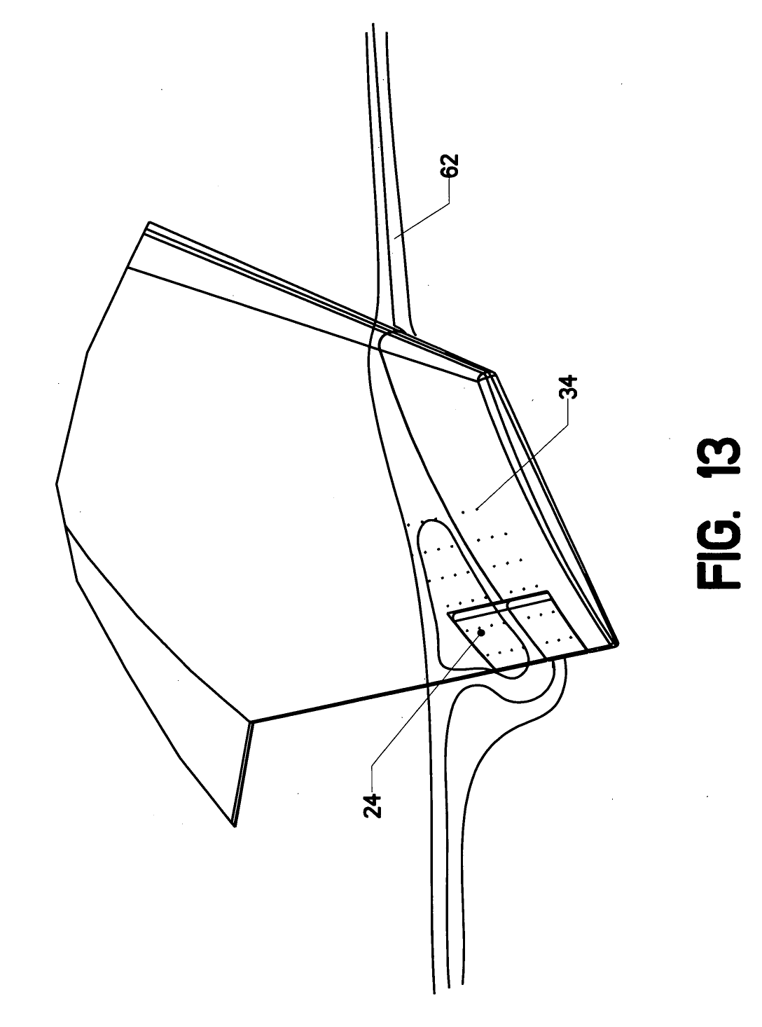

Microjet arrays can also be used to induce flow separation. FIG. 13 shows this phenomenon. First jet array 34 lies within the attached region of flow. If it is activated, it can actually force the boundary layer away from the wing surface and bring the leading portion of separated flow zone 24 forward. By comparing FIG. 13 to FIG. 12, the reader will observe how activating a microjet array in the appropriate location can increase flow separation and further reduce the lift produced by the wing.

Now that the reader understands these flow control techniques, their application in creating aircraft control forces can be appreciated. FIG. 14 shows wing 46 in its entirety. The far microjet cluster is operated to prevent flow separation, whereas the near microjet cluster is operated to actually promote flow separation. Unseparated flow 60 exists over the far cluster whereas separated flow 58 exists over the near cluster. The far portion of the wing generates more lift in this state, thereby creating a rolling moment (or rolling torque) tending to put the aircraft into a right bank.

Setting the microjet arrays for the opposite states will create a roll into a left bank. Additional microjet arrays can be positioned to create pitch and yaw moments (or torques). Thus, it is possible to create controlling forces without the need to deflect any movable control surfaces.

Having thus described the general operation and potential application of the microjets, a more detailed explanation of their operation will facilitate the reader's understanding. The microjet shown in FIG. 6 comprises a simple cylindrical tube.

Experimentation suggests that the ratio of the microjet momentum to the freestream momentum may be an important parameter. An expression can be developed to quantify the effect of mass and momentum flux input. The mass flux coefficient, M*, and the steady momentum coefficient are defined in the following:
M=(Mass Input)/(Mass deficit based on δ),
where δ is the boundary layer thickness at the leading portion of the ramp. The mass input, m* produced by the microjets is estimated by assuming choked flow through micro-nozzles. The resulting (non-general) expression for the mass flux coefficient is then:

$${M}^{*} = \frac{{m}^{*}}{{ρ}_{∞} {U}_{∞} z δ} ,$$

where ρ_{∞} is the freestream density, U_{∞} is the freestream velocity, and z is the width of the model. The conventional definition of the steady momentum coefficient is used, and is given as:

$${C}_{μ} = \frac{{NM}^{*} {U}_{j}}{0.5 * {U}_{∞}}$$

where N is the number of microjets and Uⱼ is the jet velocity.

The steady momentum coefficient is proportional to the square of the mass flux coefficient, meaning that small changes in the mass flux coefficient produce larger changes in the steady momentum coefficient. Higher steady momentum coefficients produce higher velocities near the ramp surface, indicating higher momentum near the wall (and consequently less likelihood of flow separation).

The reason behind this higher momentum is that with an increase in the steady momentum coefficient, (1) Momentum is directly injected into the boundary layer, (2) Strong streamwise vortices are generated which tend to mix the higher velocity air further away from the ramp surface into the boundary layer, and (3) The microjet momentum and resulting penetration depth increases, increasing the transfer of momentum from the mainstream fluid to the boundary layer.

These explanations pertain to the use of microjets with steady flow. However, pulse microjet injection may reduce the flow mass requirements while giving comparable performance. In some circumstances, the use of a pulsed microjet may even give enhanced performance. Pulsed microjet activation can:

1. Provide the same control effect with less mass flow. In some cases, the mass flow can be reduced to as low as 40% of the steady injection mass flow rate;

2. Provide better control, such as providing better noise reduction for impinging jets;

3. Extend the operating regime of systems by reducing unwanted effects (such as excessive noise or unwanted flow separation) in areas where steady control was not as effective; and

4. Reducing overall bleed flow needed to support a complex array of microjets.

The use of sensors to detect the flow state has been mentioned previously. Although the exact placement of sensors will depend on the application, they should generally be located so as to provide the maximum information regarding the state of the system. As a simple example, an unsteady pressure transducer can be located along a boundary where flow separation is likely to occur.

The information provided by the sensors will be processed through a controller and used to determine the appropriate microjet operating parameters. The controller would then activate the appropriate microjets to produce the desired effect. In the event of a pulsed microjet, the controller will also need to determine pulsing frequency, amplitude, and duty cycle.

Those skilled in the art will know that many types of sensors could provide useful information to such a system. These include hot-film, hot wire, strain gages, mechanical flutter gages, and temperature sensors.

Accordingly, the reader will appreciate how the use of microjets can reduce or eliminate flow separation in the region of a negative pressure gradient, and also how the use of microjets can actually promote flow separation where desired. Although the preceding description contains significant detail, it should not be construed as limiting the scope of the invention but rather as providing illustrations of the preferred embodiments of the invention. As an example, although a simple cylindrical flow passage was described for the microjet, much more complex shapes could be used. A straight portion designed to bring the Mach number up to unity could be connected to a DeLaval-type expansion nozzle. Such an arrangement would produce strongly supersonic injection velocities. Such a change would not alter the basic operative concepts of the invention.

The reader should also bear in mind that although the illustrations have focused on compressible flow (through air), the invention also has application to incompressible fluids. Flow separation occurs in hydrodynamic control surfaces such as those found on submarines. Microjet arrays can be used to control these phenomena as well. Thus, the invention should be understood in a broad sense, as set forth in the following claims.

1. In a surface having an adverse pressure gradient, wherein said surface is placed in a moving fluid stream, a flow separation control system comprising:
a. at least one microjet, positioned on said surface proximate said adverse pressure gradient; and
b. a pressurized fluid supply connected to said at least one microjet so that said microjet injects a stream of pressurized fluid into said moving fluid stream proximate said adverse pressure gradient.

2. A flow separation control system as recited in claim 1, further comprising:
a. a controller for selectively connecting said pressurized fluid supply to said at least one microjet; and
b. a flow separation sensor, positioned to sense flow separation proximate said adverse pressure gradient, wherein said flow separation sensor is in communication with said controller so that when said flow separation sensor senses said flow separation, said controller connects said pressurized fluid supply to said at least one microjet.

3. A flow separation control system as recited in claim 1, wherein said pressurized fluid supply comprises gas compressed by an aircraft engine.

4. A flow separation control system as recited in claim 2, wherein said controller is capable of rapidly altering said connection between said pressurized fluid supply and said at least one microjet so that said at least one microjet injects a pulsed stream of pressurized fluid into said moving fluid stream proximate said adverse pressure gradient.

5. In a surface having a leading portion, a trailing portion, and an adverse pressure gradient therebetween, wherein said surface is placed in a moving fluid stream, a flow separation control system comprising:
a. a first microjet, positioned on said surface proximate said adverse pressure gradient and proximate said leading portion;
b. a second microjet, positioned on said surface proximate said adverse pressure gradient and between said first microjet and said trailing portion;
c. a pressurized fluid supply connected to said first microjet so that said first microjet injects a stream of pressurized fluid into said moving fluid stream proximate said adverse pressure gradient; and
d. a pressurized fluid supply connected to said second microjet so that said second microjet injects a stream of pressurized fluid into said moving fluid stream proximate said adverse pressure gradient

6. A flow separation control system as recited in claim 5, further comprising:
a. a controller for selectively connecting said pressurized fluid supply to said first microjet and independently to said second microjet; and
b. a flow separation sensor, positioned to sense flow separation proximate said adverse pressure gradient, wherein said flow separation sensor is in communication with said controller so that when said flow separation sensor senses said flow separation, said controller connects said pressurized fluid supply to said first microjet, said second microjet, or said first and second microjet.

7. In a surface having an adverse pressure gradient, wherein said surface is placed in a moving fluid stream, a flow separation control system comprising:
a. a plurality of microjets, positioned on said surface proximate said adverse pressure gradient; and
b. a pressurized fluid supply connected to said plurality of microjets so that each of said plurality of microjets is capable of injecting a stream of pressurized fluid into said moving fluid stream proximate said adverse pressure gradient.

8. A flow separation control system as recited in claim 7, further comprising:
a. a controller for selectively connecting said pressurized fluid supply to each of said plurality of microjets; and
b. a flow separation sensor, positioned to sense flow separation proximate said adverse pressure gradient, wherein said flow separation sensor is in communication with said controller so that when said flow separation sensor senses said flow separation, said controller connects said pressurized fluid supply to one or more microjets within said plurality of microjets.

9. A flow separation control system as recited in claim 5, wherein said pressurized fluid supply comprises gas compressed by an aircraft engine.

10. A flow separation control system as recited in claim 6, wherein said pressurized fluid supply comprises gas compressed by an aircraft engine.

11. A flow separation control system as recited in claim 7, wherein said pressurized fluid supply comprises gas compressed by an aircraft engine.

12. A flow separation control system as recited in claim 8, wherein said pressurized fluid supply comprises gas compressed by an aircraft engine.

13. A flow separation control system as recited in claim 6, wherein said controller is capable of rapidly altering said connection between said pressurized fluid supply and said first and second microjets so that said microjets inject a pulsed stream of pressurized fluid into said moving fluid stream proximate said adverse pressure gradient.

14. A flow separation control system as recited in claim 8, wherein said controller is capable of rapidly altering said connection between said pressurized fluid supply and said plurality of microjets so that said microjets inject a pulsed stream of pressurized fluid into said moving fluid stream proximate said adverse pressure gradient.

15. In an aircraft, wherein said aircraft is placed in a moving fluid stream, an aircraft control system comprising:
a. at least one surface with an adverse pressure gradient, positioned on said aircraft such that the prevention of flow separation proximate said adverse pressure gradient will create asymmetric flow over said aircraft and an induced torque;
b. at least one microjet, positioned on said surface proximate said adverse pressure gradient;
c. a pressurized gas supply connected to said at least one microjet so that said microjet injects a stream of pressurized gas into said moving fluid stream proximate said adverse pressure gradient; and
d. a controller for selectively connecting said pressurized gas supply to said at least one microjet.

16. An aircraft control system as recited in claim 15, further comprising a flow separation sensor, positioned to sense flow separation proximate said adverse pressure gradient, wherein said flow separation sensor is in communication with said controller so that when said flow separation sensor senses said flow separation, said controller connects said pressurized gas supply to said at least one microjet.

17. An aircraft control system as recited in claim 15, wherein said pressurized gas supply comprises gas compressed by an aircraft engine.

18. An aircraft control system as recited in claim 15, wherein said controller is capable of rapidly altering said connection between said pressurized gas supply and said at least one microjet so that said at least one microjet injects a pulsed stream of pressurized gas into said moving fluid stream proximate said adverse pressure gradient.

19. An aircraft control system as recited in claim 16, further comprising a flow separation sensor, positioned to sense flow separation proximate said adverse pressure gradient, wherein said flow separation sensor is in communication with said controller so that when said flow separation sensor senses said flow separation, said controller connects said pressurized gas supply to said at least one microjet.

20. An aircraft control system as recited in claim 19, wherein said pressurized gas supply comprises gas compressed by an aircraft engine.
